(19) United States
(12) Patent Application Publication
(10) Pub. No.: US 2026/0138520 A1
(43) Pub. Date: May 21, 2026

(54) Tie-Down Apparatus Adaptable for Varying Cargo

(71) Applicant: Walther Innovations, LLC, Slinger, WI (US)

(72) Inventor: Andrew Walther, Slinger, WI (US)

(73) Assignee: Walther Innovations, LLC, Slinger, WI (US)

(21) Appl. No.: 19/389,978

(22) Filed: Nov. 14, 2025

Related U.S. Application Data
(60) Provisional application No. 63/721,188, filed on Nov. 15, 2024.

(51) Int. Cl. B60P 7/08; B60P 7/10

(52) U.S. Cl. CPC B60P 7/0823; B60P 7/10

(57) ABSTRACT

Tie-down apparatus for securement of cargo of varying size, shape and mass on a cargo-bearing vehicle surface, the tie-down apparatus including: an inner strapping loop including at least three inner-loop strapping portions each having a pair of ends, one of which is affixed to an end of an adjacent inner-loop strapping portion at an inner-loop juncture and the other of which is affixed to yet another adjacent inner-loop strapping portion at another inner-loop juncture, inner-loop strapping portions having a length adjuster positioned therealong; an outer strapping loop including at least three inner-loop strapping portions each affixed to an adjacent inner-loop strapping portion at an outer-loop juncture, each inner-loop juncture being affixed to a respective outer-loop strapping portion at a middle position of such outer-loop strapping portion; and preferably at least one outer-loop extender extending from each outer-loop juncture and including a distal-connector for vehicle attachment.

### FIELD OF THE INVENTION

The invention relates generally to the field of securing cargo for shipping or transport purposes in vehicles, and more specifically to the field of tie-down apparatus used for such purposes.

### BACKGROUND OF THE INVENTION

Securing loads in moving vehicles can be challenging and typically is accomplished using standard devices such as ratcheting tie straps, rope, or bungee cords. These devices are usually sufficient for cargo with eyebolts, hooks, loops, or other means of attachment. These are most commonly applied to manufactured cargo, lower-standing cargo, and cargo with facets or protrusions capable of accepting and holding a standard load binding method. When securing oddly-shaped cargo, large cargo, or cargo that is taller, this becomes even more challenging, particularly when dealing with securement of cargo of widely-varying shapes, sizes and mass.

By way of more specific example, with cargo that is tall, the center of gravity is typically much higher, and the moment of tipping becomes more concerning. Consider the example of securing a refrigerator within the open bed of a pickup truck or open utility trailer. Standard tie straps, rope, bungee cords, ratcheting devices, etc., cannot accomplish securing such cargo safely and effectively without fear of the binding slipping off, or the cargo shifting and falling over in transit. This is not only a safety concern for the condition of the cargo itself, but if a tipping or shifting event occurred, the cargo could leave the confines of the open bed of a truck or trailer or other transport vehicle and become a hazard to persons within close proximity. Of course, this also risks damaging the cargo.

Just by way of further example, the wide variety of cargo objects that need to be dealt with when it comes to securement to the transport vehicle can include propane tanks, machinery or implements of various kinds, furniture, appliances, buckets, lumber, piping, coolers, loose materials, gas cans—the list could go on forever. And, the variability goes well beyond the load. Depending on the nature of the transport vehicle such as a pickup truck, trailer or other vehicle being used, the tie-down points can be in widely varying positions, and this too makes tie-down tasks difficult.

Of course, given all the variability of cargo loads and vehicles and trailers used, one can resort to using many straps, ropes, bungee cords, extreme taping, etc., to make a cargo load secure in or on the vehicle (e.g., the flat bed of a pickup truck or a trailer), but this takes much time and effort, including immediate planning and obtaining of needed materials and/or devices, and also frequently requires the use of helpers to secure the cargo load or object in an acceptable manner.

In other words, there are many greatly varying loads to be hauled in the open bed of a pickup truck, trailer, or other cargo vehicle, with their varying tie-down securement points or possibilities, and there has long been a need for improved securement apparatus which, by virtue of its nature, can accommodate such varying cargo items and loads as well as the varying vehicle situations encountered. It is to this problem and these difficulties that the present invention is addressed.

### SUMMARY OF THE INVENTION

This invention is an improved tie-down apparatus adaptable for cargo items and loads of greatly varying size, shape and mass. The invention addresses and overcomes the above-described problems and difficulties and provides low-cost apparatus that is not only easily adaptable to these problems but is easy to use and easy to store when not in use. It makes securement of objects for shipping safer and quicker, and easy to be accomplished by one person, such as the owner of the pickup truck or trailer.

The tie-down apparatus of this invention includes: (A) an inner strapping loop (a loop of strapping) having at least three inner-loop strapping portions each with a pair of ends, one of which is affixed to an end of an adjacent inner-loop strapping portion at an inner-loop juncture and the other of which is affixed to yet another adjacent inner-loop strapping portion at another inner-loop juncture, with inner-loop strapping portions having a length adjuster positioned therealong between inner-loop junctures; (B) an outer strapping loop having at least three outer-loop strapping portions each affixed to an adjacent outer-loop strapping portion at an outer-loop juncture, each inner-loop juncture being affixed to a respective outer-loop strapping portion at a middle position of such outer-loop strapping portion; and (C) at least one outer-loop extender extending from each outer-loop juncture and including a distal-connector at a distal position.

Highly preferred embodiments of the invention have their inner strapping loop including only three inner-loop strapping portions and their outer strapping loop including only three outer-loop strapping portions. However, rather than triangular inner loops within triangular outer loops, the invention also includes polygonal configurations other than triangular. For example, the inner and outer strapping loops could each have four or more strapping portions and provide the advantages of the invention. (It should be understood that the terms “triangular” and “polygonal” as used herein refers only to the number of inner-loop strapping portions and the number of outer-loop strapping portions, and not to the shapes of the loops, because the strapping portions are flexible rather than linear and so can be in virtually any shape, and indeed form whatever shape or shapes is/are necessary and appropriate to best accommodate the cargo that is being engaged.)

In all preferred embodiments of the invention, the outer-loop extenders are of adjustable length. It is preferred that the outer-loop extenders include a strap slider which serves length-adjustment purposes.

Preferred embodiments also include at least a pair of outer-loop extenders from at least one, or most preferably, each of the outer-loop junctures, with the distal-connectors of the outer-loop extenders being an engagement ring or hook for engagement with the vehicle or other distal anchoring (engagement) point. Having plural outer-loop extenders not only gives choices of how best to use the apparatus to secure to the vehicle, and what to use for vehicle attachment, but also allows plural attachments from each, or at least some, of the outer-loop junctures.

In certain highly preferred embodiments, at least one of the outer-loop junctures of the outer strapping loop includes, and most preferably each of the outer-loop junctures includes, a joining ring joining the corresponding pair of outer-loop strapping portions and also joining a corresponding one (or more) of the outer-loop extenders.

Preferred embodiments of the invention have inner-loop strapping portions with length adjusters between the inner-loop junctures in the form of strap-clamping buckles. This facilitates quick adjustment of the triangular (or other polygonal) configuration to accommodate cargo items of substantially different sizes. And it facilitates the inventive apparatus having an enveloping quality to accommodate cargo items of various sizes and shapes.

Another aspect of the tie-down apparatus of this invention involves most of the above-described apparatus but terminating with the above-described joining rings at the outer-loop junctions. Such joining rings can serve to accommodate either direct connection of one or more of them to separate engagement points on or adjacent to a truck bed or other shipping vehicle or, more frequently, serve as connection points for common rope or the like extending from each of such joining rings to engagement points on or adjacent to a truck bed or other shipping vehicle. In such cases, the inventive tie-down apparatus serves to well secure the item or items in place for shipping purposes, accommodating cargo items of substantially different sizes and shapes. Still more broadly considered, the joining ring(s) referred to above can be a wide variety of other joiners which provide connection points for rope or the like extending therefrom to engagement points on or adjacent to a truck bed or other shipping vehicle.

The inventive apparatus, despite its great adaptability and significant utility can readily be stored in or on a vehicle or the like, with little or no difficulty or loss of other shipping volume when not in use. Given that the overall construction of this apparatus is soft and pliable in nature, it is easily collapsible and stowable in any vehicle, taking up little to no space, and/or easily hung on a garage wall while using little space. And, upon deployment, it can be easily affixed to any of a wide variety of cargo items by a single person and provide secure transport of the cargo.

The intention is that the inventive apparatus have very broad or close to universal usefulness for securement of a great variety of cargo. The tie-down apparatus of this invention is readily usable for cargo of a wide variety of shapes and sizes. This includes boxes and box-shaped cargo, including particularly heavy items and appliances such as refrigerators, dressers and cabinets, cylindrical items such as drums, even 55-gallon drums, and oddly-shaped items and collections of items. And the tie-down apparatus of this invention can come in a normal size for use, e.g., in typical pickup truck shipments. Or such apparatus can be in a significantly larger size such as may be useful for much larger loads, e.g., in much larger vehicles.

In summary, the triangle-within-triangle (or more broadly polygon-within-polygon) configuration of the apparatus of this invention, along with its several strap-extending and shape-adjusting features and variations, together provide the great adaptability which serves the intended purposes of this invention.

As used in describing this invention, the term “strapping” and “strap” has a meaning broader than the most common meaning. The term refers to any flexible, strong elongate material of the sort that can wrap and flexibly bend, for securement purposes, but is not necessarily stretchable; indeed, little or no stretchability is preferred. The strapping may be of strapping material of strong closely-woven material, or of various strong polymeric materials which are supple and tend to conform to the shapes of items over which they are spread or wrapped. Acceptable choices of a wide variety of materials for strapping will be apparent to those skilled in the shipping and packing arts who have been made aware of the disclosures of this invention.

While the “strapping” referred to herein is broadly defined to embrace flexible elongate members of widely differing cross-sectional shapes, flat flexible belt-like materials are highly preferred, and this preferred form of strap or strapping is referred to herein as “flat-strapping.”

The term “loop” as used herein is always used with respect to what is formed by inner-loop strapping portions of what is formed by outer-loop strapping portions.

The term “middle position” as used with respect to the location where an inner-loop juncture is attached along one of the outer-loop strapping portions does not necessarily mean exactly halfway between the ends of the outer-loop strapping portion. The inner-loop juncture could be attached to the outer-loop strapping portion anywhere in the middle area other than very close to one of the ends of the outer-loop strapping portion. In some embodiments the position of such attachment can be adjustable.

The terms “proximal” and “distal” as used herein refers to the functional ends, such that with respect to “distal,” any further portion therebeyond would provide no attachment or holding function, unless perhaps an additional length is attached for a separate or additional attachment or holding function.

The term “vehicle” or “cargo-bearing vehicle” refers to any sort of apparatus or devices to which cargo is secured for shipping purposes. This may include pickup trucks, trucks of any sort, and trailers of any sort. The terms are to be broadly construed.

The terms “triangular” and “polygonal” as used herein are explained above.

### BRIEF DESCRIPTION OF THE FIGURES

FIG. 1A is a perspective view of a preferred embodiment of the tie-down strapping apparatus of this invention.

FIG. 1B is a detailed perspective view illustrating adjustability of the length of an inner-loop strapping portion of the apparatus of FIG. 1, but in the view including an enlarged buckle.

FIG. 2 is a perspective view of another embodiment of the tie-down strapping apparatus of this invention, this embodiment including outer-loop extenders.

FIGS. 3A-3C are three perspective views illustrating various exemplary outer-loop extenders which are portions of certain embodiments of the invention. More specifically:

FIG. 3A is a perspective view of a length-extending extender for connection to a distal-connector of an outer-loop extender or directly to an outer-loop juncture.

FIG. 3B is a perspective view of an outer-loop extender of the apparatus shown in FIG. 2.

FIG. 3C is a perspective view of an embodiment of another outer-loop extender, in this case permanently secured to a ring forming the juncture of adjacent outer-loop strapping portions of the apparatus shown in FIG. 1A.

FIG. 4A is a perspective view illustrating an exemplary use of one apparatus of the invention applied to secure an item of cargo on a vehicle.

FIG. 4B is a rear perspective view showing the apparatus and the secured cargo item of FIG. 4A.

The embodiments shown in the above figures should be understood to be exemplary, with many variations being possible. Similar parts and portions of such embodiments illustrated above will be identified by the same numerals. Certain details of these and other preferred embodiments of the invention and their features are referred to and/or described in the detailed description which now follows.

### DETAILED DESCRIPTION OF PREFERRED EMBODIMENTS

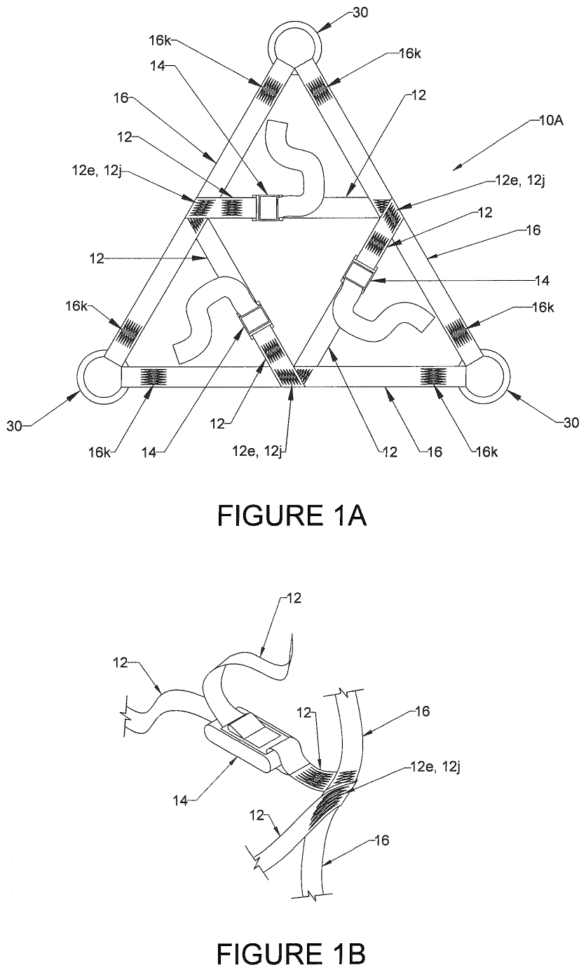

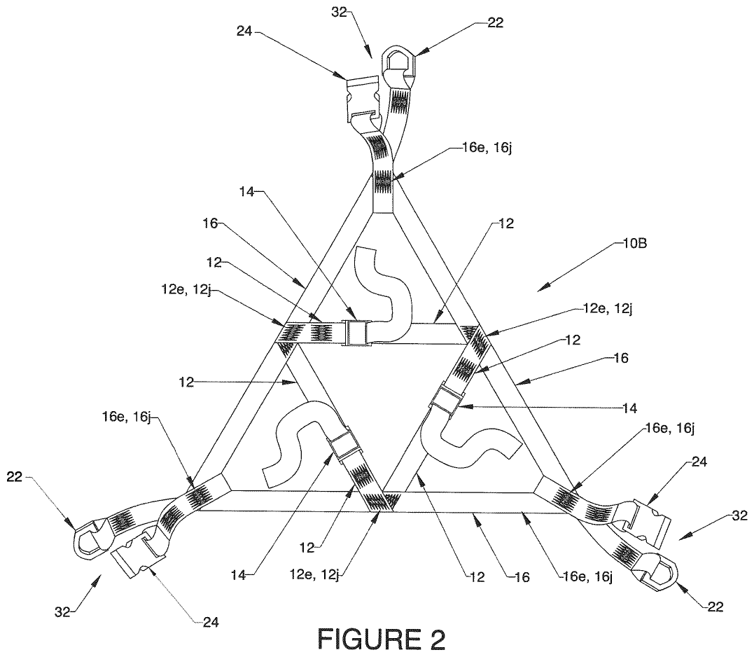

FIGS. 1A and 2 show preferred embodiments 10A and 10B, respectively, of the present invention. Tie-down 10A in FIG. 1A and tie-down apparatus 10B in FIG. 2 are similar to one another in most respects, but the following description will refer to each apparatus specifically, with similar numerals used as appropriate as indicated above.

Apparatus 10A, shown in FIG. 1A, includes an inner strapping loop (a loop of strapping) having and formed by three inner-loop strapping portions 12, each with a pair of opposite ends 12e, one of which is affixed to an end 12e of an adjacent inner-loop strapping portion 12 at an inner-loop juncture 12j, and the other of which is affixed to yet another adjacent inner-loop strapping portion 12 at another inner-loop juncture 12j. Each inner-loop strapping portion 12 has a strap-clamping buckle 14 positioned therealong which serves as an adjuster for the length of inner-loop strapping portion 12. FIG. 1B shows strap-clamping buckle 14 which clamps overlying lengths together with such inner-loop strapping portion 12 at the desired length for the specific intended cargo-holding task.

Apparatus 10A also includes an outer strapping loop (again, a loop of strapping) which has and is formed by three outer-loop strapping portions 16, each with a pair of ends 16k, each of which affixed to a corresponding attachment point 30, shown in FIG. 1A as a joining ring 30. Joining rings 30 serve as points for connection to flexible elongate members (extenders) which can extend to whatever anchoring (engagement) point is available for securement to a cargo-bearing vehicle surface.

Apparatus 10B in FIG. 2 is a similar apparatus to apparatus 10A in FIG. 1 in most respects, but the following description will refer to apparatus 10B in particular, with similar numerals used as appropriate and as indicated above.

Apparatus 10B includes an inner strapping loop (a loop of strapping) having and formed by three inner-loop strapping portions 12, each with a pair of ends 12e, one of which is affixed to an end 12e of an adjacent inner-loop strapping portion 12 at an inner-loop juncture 12j and the other of which is affixed to yet another adjacent inner-loop strapping portion 12 at another inner-loop juncture 12j. Each inner-loop strapping portion 12 has a strap-clamping buckle 14 positioned therealong which serves as an adjuster for the length of inner-loop strapping portion 12. Apparatus 10B also includes an outer strapping loop (again, a loop of strapping) which has and is formed by three outer-loop strapping portions 16, each with a pair of ends 16e, each of which is affixed to an end 16e of an adjacent outer-loop strapping portion 16 at an outer-loop juncture 16j. Each inner-loop juncture 12j is affixed to a respective one of outer-loop strapping portion 16 at a middle position of such outer-loop strapping portion by robust stitching. An outer-loop extender 32 extends from each outer-loop juncture 16j.

The junctures 16j of adjacent outer-loop strapping portions 16 are formed by strapping portions 16 being stitched together rather than joined at a joining ring 30 as in apparatus 10A. Each outer-loop extender 32 includes a strap also stitched at a corresponding juncture 16j, the outer-loop extenders 32 serving as flexible elongate members or portions thereof for purposes of extending to whatever anchoring point is available for securement of cargo.

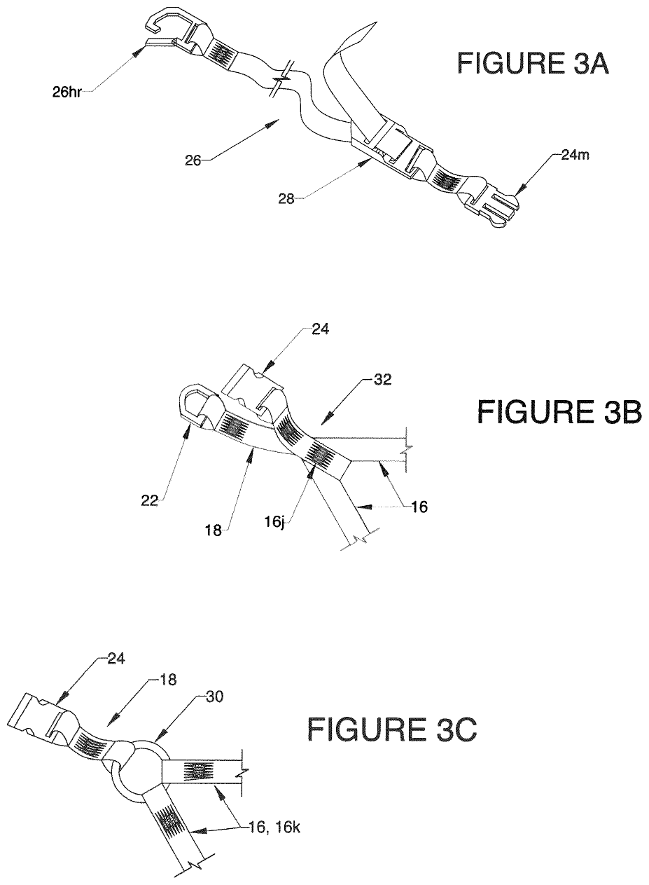

FIG. 3A illustrates a length-extending extender 26 which is configured for quick and easy engagement with a distal-connector such as distal connectors 22 (shown in FIGS. 2 and 3B) or 24 (shown in FIGS. 3B and 3C). The length-extending extenders, however configured, serve the purpose of adapting the inventive apparatus for connection to distal anchoring points wherever located, such as on a vehicle. More specifically, length-extending extender 26 has a male slip-in clasp member 24m at one end which is click-engageable with slip-in clasp 24, and the other end of length-extending extender 26 has a hooking ring 26hr. Outer-loop extenders such as 32 and 18 provide a choice in what to use for engagement with a proximal end of length-extending extenders 26. Length-extending extender 26 also includes a buckle 28 for adjusting its length such that its distal end reaches an anchoring point for engagement therewith.

In some instances, hooking ring 26hr of length-extending extender 26 may be connected directly to ring 30 of apparatus 10A of FIG. 1A. In such instances, length-extending extender 26 itself becomes the outer-loop extender extending from an outer-loop juncture of apparatus 10A to an anchoring point. As appropriate, the configuration of a length-extending extender, particularly its connectors at its ends, can vary to facilitate connections.

FIG. 3C shows outer-loop extender 18 permanently secured with stitched strapping to ring 30 that forms the juncture of adjacent outer-loop strapping portions of the apparatus shown in FIG. 1A. Outer-loop extender 18 includes an exemplary distal connector 24 for snap connection like male slip-in clasp member 24m, such as of length-extending extender 26.

These illustrated embodiments are not intended to be limiting but serve to indicate the many choices available in securing various loads. As illustrated in FIGS. 2, 3B and 3C, outer-loop extenders 18 and 32 are not shown as particularly long. In most applications however, embodiments of the invention will have considerably longer outer-loop extenders and be of adjustable length. It is preferred that outer-loop extenders each include a strap slider and strap-clamping buckle (not shown) which serve length-adjustment purposes for outer-loop extenders. A wide variety of distal-connectors can be used, depending on what sort of anchoring point is available for use during cargo securement.

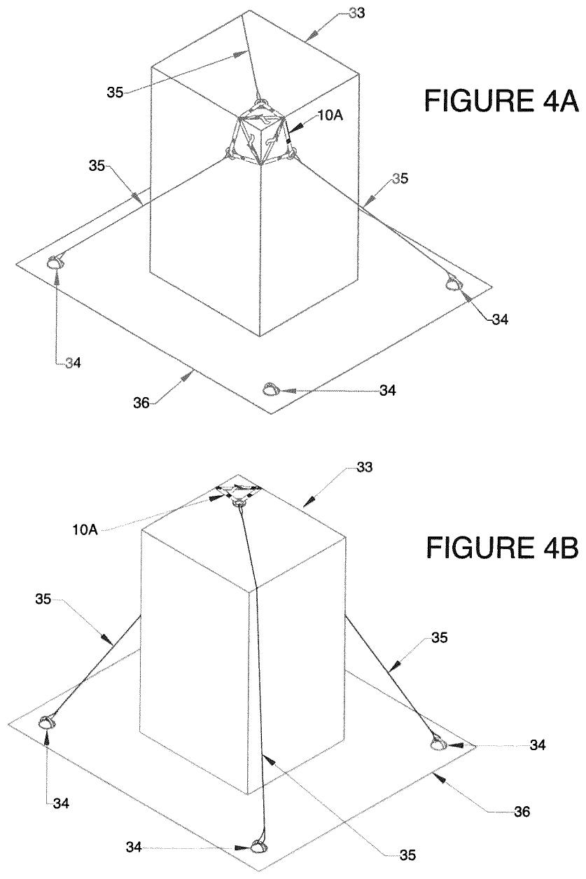

FIG. 4A illustrates an intended use of the apparatus applied to an item of cargo, and FIG. 4B shows this usage from the rear. Apparatus 10A is applied to the corner of an item of cargo 33. Each of the three connection points (rings 30) is fastened to a permanent anchoring point 34 using an outer-loop extender 35 in the form of a rope. Outer-loop extenders 35 are shown generically in this diagram, but instead could be straps, chains, cables or other similar elongate members. In this example, the distal ends of outer-loop extenders 35 are attached to anchoring points within a cargo bay 36 of a vehicle. In some situations, depending on the size, shape and weight of the cargo item, it may be appropriate to use more than one of the tie-down apparatuses of this invention to assure stability.

While the present invention has been described in particular embodiments, it should be appreciated that the present invention should not be construed as limited by such embodiments but rather construed in accordance with the claims included herein and their equivalents.

1. Tie-down apparatus for securement of cargo on a cargo-bearing vehicle surface, the tie-down apparatus comprising:
an inner strapping loop including at least three inner-loop strapping portions each having a pair of ends one of which is joined to an end of an adjacent inner-loop strapping portion at an inner-loop juncture and the other of which is joined to yet another adjacent inner-loop strapping portion at another inner-loop juncture, each inner-loop strapping portion including a length adjuster positioned therealong between its inner-loop junctures;
an outer strapping loop including at least three outer-loop strapping portions each having a pair of ends one of which is joined to an adjacent outer-loop strapping portion at an outer-loop juncture and the other of which is joined to yet another adjacent outer-loop strapping portion at another outer-loop juncture, each inner-loop juncture being attached to a respective outer-loop strapping portion at a middle position of such outer-loop strapping portion; and
at least one outer-loop extender extending from each outer-loop juncture and including a distal-connector at a distal position.

2. The tie-down apparatus of claim 1 wherein the outer-loop extender is of adjustable length.

3. The tie-down apparatus of claim 2 wherein the outer-loop extender includes a strap slider for length-adjustment purposes.

4. The tie-down apparatus of claim 1 including at least a pair of outer-loop extenders from at least one of the outer-loop junctures, the distal-connector of at least one of the pair of outer-loop extenders being an engagement ring or hook for engagement with a distal engagement point.

5. The tie-down apparatus of claim 1 including at least a pair of outer-loop extenders from each of the outer-loop junctures, the distal-connector of at least one of each pair of outer-loop extenders being an engagement ring or hook for engagement with a distal engagement point.

6. The tie-down apparatus of claim 1 wherein the length adjusters between the inner-loop junctions are strap-clamping buckles.

7. The tie-down apparatus of claim 6 wherein the outer-loop extender is of adjustable length.

8. The tie-down apparatus of claim 7 wherein the outer-loop extender includes a strap slider for length-adjustment purposes.

9. The tie-down apparatus of claim 6 including at least a pair of outer-loop extenders from at least one of the outer-loop junctures, the distal-connector of at least one of the pair of outer-loop extenders being an engagement ring or hook for engagement with a distal engagement point.

10. The tie-down apparatus of claim 9 including at least a pair of outer-loop extenders from each of the outer-loop junctures, the distal-connector of at least one of each pair of outer-loop extenders being an engagement or hook for engagement with a distal engagement point.

11. The tie-down apparatus of claim 1 wherein the inner strapping loop has only three inner-loop strapping portions and outer strapping loop has only three outer-loop strapping portions.

12. The tie-down apparatus of claim 1 wherein at least one of the outer-loop junctures joining a pair of the adjacent outer-loop strapping portions includes a joining ring to which at least one of the outer-loop extenders is also joined.

13. The tie-down apparatus of claim 12 wherein each of the outer-loop junctures joining a specific pair of the adjacent outer-loop strapping portions includes a respective joining ring to which at least a corresponding one of the outer-loop extenders is also joined.

14. The tie-down apparatus of claim 1 further including at least one length-extending extender joined to at least one of the outer-loop extenders.

15. Tie-down apparatus for securement of cargo on a cargo-bearing vehicle surface, the tie-down apparatus comprising:
an inner strapping loop including at least three inner-loop strapping portions each having a pair of ends one of which is joined to an end of an adjacent inner-loop strapping portion at an inner-loop juncture and the other of which is joined to yet another adjacent inner-loop strapping portion at another inner-loop juncture, each inner-loop strapping portion including a length adjuster positioned therealong between its inner-loop junctures;
an outer strapping loop including at least three outer-loop strapping portions each having a pair of ends one of which is joined to an adjacent outer-loop strapping portion at an outer-loop juncture and the other of which is joined to yet another adjacent outer-loop strapping portion at another outer-loop juncture, each of the outer-loop junctures including a joining ring whereby each outer-loop juncture and thus the tie-down apparatus may be secured to hold the cargo on the cargo-bearing vehicle surface, and each inner-loop juncture being attached to a respective outer-loop strapping portion at a middle position of such outer-loop strapping portion.

16. The tie-down apparatus of claim 15 wherein the inner strapping loop has only three inner-loop strapping portions and outer strapping loop has only three outer-loop strapping portions.

17. The tie-down apparatus of claim 15 further including at least one length-extending extender joined to at least one of the outer-loop extenders.

18. Tie-down apparatus for securement of cargo on a cargo-bearing vehicle surface, the tie-down apparatus comprising:
an inner strapping loop including at least three inner-loop strapping portions each having a pair of ends one of which is joined to an end of an adjacent inner-loop strapping portion at an inner-loop juncture and the other of which is joined to yet another adjacent inner-loop strapping portion at another inner-loop juncture, each inner-loop strapping portion including a length adjuster positioned therealong between its inner-loop junctures;
an outer strapping loop including at least three outer-loop strapping portions each having a pair of ends one of which is joined to an adjacent outer-loop strapping portion at an outer-loop juncture and the other of which is joined to yet another adjacent outer-loop strapping portion at another outer-loop juncture, each of the outer-loop junctures including a joiner whereby each outer-loop juncture and thus the tie-down apparatus may be secured to hold the cargo on the cargo-bearing vehicle surface, and each inner-loop juncture being attached to a respective outer-loop strapping portion at a middle position of such outer-loop strapping portion.

19. The tie-down apparatus of claim 18 wherein the inner strapping loop has only three inner-loop strapping portions and outer strapping loop has only three outer-loop strapping portions.

20. The tie-down apparatus of claim 18 further including at least one length-extending extender joined to at least one of the outer-loop extenders.
